(19) United States
(12) Patent Application Publication
(10) Pub. No.: US 2005/0258008 A1
(43) Pub. Date: Nov. 24, 2005

(54) Caliper cover

(76) Inventor: William J. King, Ridgewood, NJ (US)

Correspondence Address: Ruth Eure, 4795 Edison Avenue, Boulder, CO, 80301, US

(21) Appl. No.: 10/850,192

(22) Filed: May 20, 2004

(51) Int. Cl. F16D 65/78

(52) U.S. Cl. 188/264 R

(57) ABSTRACT

This invention provides caliper covers having vent openings, caliper cover kits, and methods for cooling caliper brake mechanisms that prevent brake fade and prevent brake malfunction caused by debris from the road, while improving the appearance of the caliper braking mechanism and preventing transfer of braking dust from the brake pads to the wheels.

### FIELD OF THE INVENTION

This invention is in the fields of disc brakes and automobile accessories.

### BACKGROUND OF THE INVENTION

In automobile disc brakes, when pressure is applied to the brake pedal, one or more pistons in each brake caliper push brake pads into contact with the disc at each wheel, thereby creating friction, converting the vehicle momentum into heat and slowing the automobile. Despite that disc brakes are the preferred type of brakes for motorized vehicles, disc brakes have several drawbacks. Disc brakes are susceptible to brake fade, a phenomenon in which brakes lose effectiveness due to overheating. Brake disc pads attached to the calipers are susceptible to damage and malfunction from water, rocks, dirt, and other debris kicked up from the road. Unattractive original equipment (O.E.) calipers are visible behind the car's wheels and particularly expensive, spoked, alloy wheels. Also, in the braking process, contact of the discs with the brake pads inside the calipers create corrosive dust and dirt that can easily migrate to visible areas of the wheels, negatively impacting their appearance temporarily and/or permanently damaging their surface.

There is a need in the art for brake caliper covers that are compact, easy to install, and prevent brake fade and malfunction while improving and complimenting the appearance of the braking mechanism and wheels.

Brake covers for vehicles are known in the art.

U.S. Designs 397,968, issued Sep. 8, 1998; 377,774, issued Feb. 4, 1997; 294,923, issued Mar. 29, 1988; and 291,189, issued Aug. 4, 1987 illustrate brake covers for motorcycles.

U.S. Pat. No. 4,360,083, issued Nov. 23, 1982, describes a disc brake protective cover plate for a tractor loader vehicle. U.S. Pat. No. 6,340,079, issued Jan. 22, 2002, describes a brake drum cover system, for hopper bottom style truck trailers.

U.S. Des. 416,526, issued Nov. 16, 1999, illustrates a simulated cross-drilled disc brake cover. U.S. Pat. No. 4,503,944, issued Mar. 12, 1985, describes a device for cooling motor vehicle wheels. U.S. Design 476,275 S, issued Jun. 24, 2003, illustrates an automobile brake caliper cover.

None of the above-mentioned brake covers are designed for covering only the caliper mechanism of the brake system and have air vents for directing air to the caliper mechanism of disc brakes.

It is an object of this invention to provide caliper covers that help prevent brake fade and prevent brake malfunction caused by debris from the road, while improving the appearance of the caliper braking mechanism and prevent transfer of brake dust from the brake pads to the wheels.

All references cited are incorporated herein by reference in their entirety to the extent that they are not inconsistent with the disclosure herein.

### SUMMARY OF THE INVENTION

This invention provides contoured caliper covers, caliper cover kits, and methods for cooling caliper brake mechanisms that help prevent brake fade and prevent brake malfunction caused by debris from the road, while improving the appearance of the caliper braking mechanism and preventing transfer of braking dust from the brake pads to the wheels.

This invention provides caliper covers comprising a plurality of vent openings for directing air to a covered caliper. This invention provides caliper covers comprising a side plate having an outer periphery, an upper plate connected to the periphery of the side plate, the upper plate having a plurality of vent openings for directing air to a covered caliper, and a caliper attachment receiving means.

The side plate and the upper plate of the caliper covers prevent debris from outside the covered caliper from contacting the covered caliper and prevent dust from inside the covered caliper from contacting a wheel. The air directed to the covered caliper helps prevent brake fading compared to an equivalent caliper cover without vent openings.

The caliper covers of this invention are useful for vehicles having three, four, or more wheels.

This invention provides caliper covers in which all of the vent openings are curvilinear in shape, including wherein a portion of the vent openings are ovals or curved triangles. Caliper covers of this invention have vent openings that are capable of preventing debris having an average diameter larger than about 0.75 inch, 0.5 inch, and/or 0.25 inch from contacting the covered caliper. This invention provides caliper covers wherein the vent openings comprise between about 1% and about 75% or between about 10% and about 25% of the area of the upper plate.

This invention provides caliper covers in which the periphery of the side plate and the upper plate are curved at about the same curvature of a disc connected to the covered caliper. Optionally the side plate and the upper plate are contiguous.

This invention provides caliper covers in which the shapes of the vent openings, the curvature of the upper plate, and/or the angle of the vent openings through the upper plate, relative to the exterior surface of the upper plate, direct air to the covered caliper.

This invention provides caliper covers in which the side plate has a second plurality of vent openings for directing air to the covered caliper. The second plurality of vent openings are optionally at about 180 degrees relative to the direction of air approaching the caliper cover when a vehicle on which the caliper cover is installed is moving forward. Optionally the side plate has a protrusion, having a front panel, for surrounding the portion of the covered caliper protruding exterior to a brake disc connected to the covered caliper, wherein the front panel optionally has vent openings for directing air to the covered caliper.

This invention provides caliper covers and kits made of aluminum alloy.

This invention provides caliper cover kits comprising a caliper cover of this invention and a means for attaching the caliper cover to the covered caliper. Optionally the means for attaching the caliper cover to the covered caliper comprises a left mounting bracket, a right mounting bracket, two screws, two springs and two hex nuts, and the caliper attachment receiving means of the caliper cover comprises two openings for accepting the two screws.

This invention provides methods for cooling a caliper breaking mechanism comprising: providing a vehicle having a disc brake; providing a caliper cover of this invention; providing a caliper cover attachment means; installing the caliper cover over a caliper of the disk brake using the attachment means; and driving the vehicle in forward or reverse whereby air is directed through the vent holes in the caliper cover directly to the caliper breaking mechanism.

This invention provides a caliper cover for a vehicle having four wheels comprising: a protruding side plate having a curved outer periphery and having about two openings for receiving caliper attaching screws, and a curved upper plate connected to the periphery of the side plate, the upper plate having vent openings for directing air to a covered caliper, wherein the vent openings comprise between about 10% to about 25% of the surface area of the upper plate, wherein the vent openings comprise about ten oval vent openings having dimensions of between about one inch and about two inches by between about 0.2 inches and about 0.33 inches, and about one curved equilateral triangular vent opening having a side dimension between about 0.5 inches and about one inch, wherein the caliper cover is made of aluminum alloy, and wherein the caliper cover prevents debris from outside the covered caliper from contacting the covered caliper, prevents dust from inside the covered caliper from contacting a wheel of the vehicle, prevents brake fading compared to an equivalent caliper cover without vent openings, and improves the appearance of the covered caliper.

### BRIEF DESCRIPTION OF THE DRAWINGS

FIGS. 1A-1D are illustrations of top, exterior side, bottom, and interior side views, respectively, of a caliper cover of this invention.

FIG. 2 is an illustration of a top front perspective view of an installed caliper cover kit of this invention.

FIGS. 3A-3C are illustrations of side, top, and back views, respectively, of installed caliper cover kits of this invention.

FIGS. 4A-4F are illustrations of side, top, and top rear perspective views of left and right mounting brackets, respectively, of caliper cover kits of this invention.

FIG. 5A is an illustration of a longitudinal cross-section of a cutaway of an upper plate showing angles of vent openings. FIG. 5B is an illustration of a cross-section through a front panel of a side plate protrusion showing angles of vent openings.

### DETAILED DESCRIPTION OF THE INVENTION

Caliper covers and kits of this invention are illustrated in the accompanying drawings. The elements of the drawings are listed in Table 1.

TABLE 1

| Number | Item |
|---|---|
| 1 | caliper cover |
| 2a | oval vent opening |
| 2b | rounded triangular vent opening |
| 3 | protrusion |
| 4 | opening for caliper attachment means |
| 5 | hub curvature |
| 6 | upper plate |
| 7 | side plate |
| 8 | disc curvature |
| 9 | cosmetic element |
| 10a | left mounting bracket |
| 10b | right mounting bracket |
| 11 | screw |
| 12 | nut |
| 13 | standard caliper |
| 14 | standard disc |
| 15 | front |
| 16 | rear |
| 17 | attachment means distance |
| 18 | cosmetic element distance |
| 19 | caliper cover width |
| 20 | protrusion depth |
| 21 | caliper cover depth |
| 22 | caliper cover side plate height |
| 23 | bracket thickness |
| 24 | center of hook opening |
| 25 | length of back panel |
| 26 | connecting panel |
| 27 | length of connecting panel |
| 28 | hook opening |
| 29 | cover attachment opening |
| 30 | width of bottom of hook opening |
| 31 | angle of hook opening |
| 32 | bracket angle |
| 33 | distance from top to center of hook opening |
| 34 | height of back panel side away from front panel |
| 35 | distance from hook opening center to cover opening center |
| 36 | back panel |
| 37 | front panel |
| 38 | front panel of protrusion if a left caliper cover |
| 39 | height of bracket |
| 40 | vent opening angle |
| 41 | direction of air approaching caliper cover |
| 42 | upper plate surface |
| 43 | vent opening angle relative to air |
| 44 | vent opening angle relative to protrusion surface |
| 45 | side plate protrusion surface |

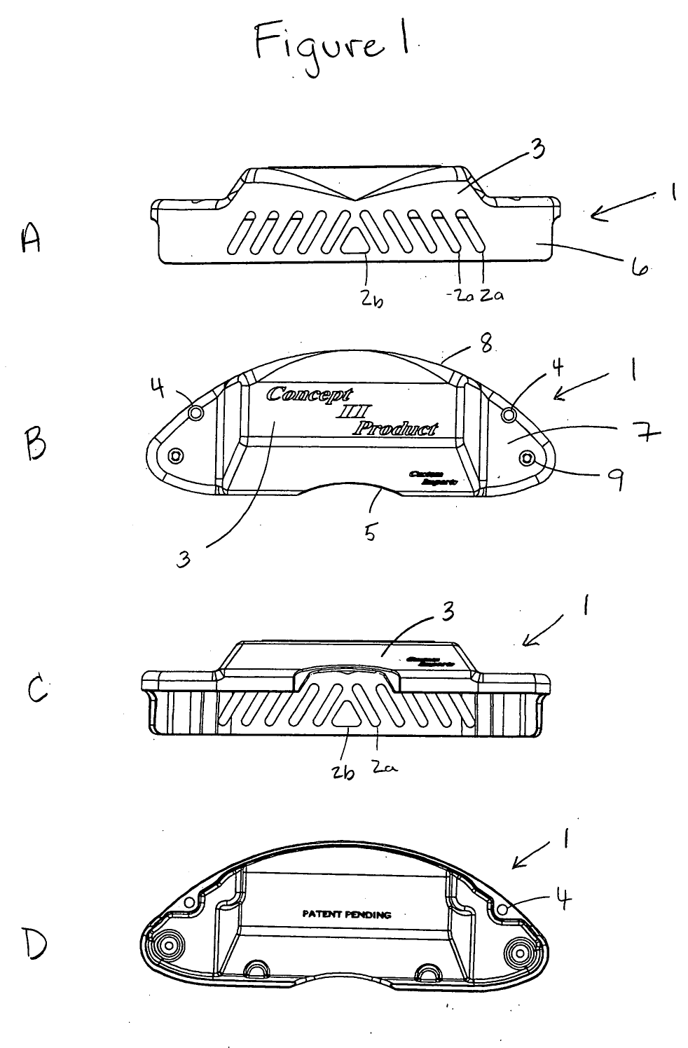

FIGS. 1A-1D show top, exterior side, bottom, and interior side views of a caliper cover 1 of this invention. In FIG. 1A, the upper plate 6, protrusion 3, oval vent holes 2a, and a triangular vent hole 2b are shown. In FIG. 1B, the side plate 7, protrusion 3, caliper attachment openings 4, and ornamental elements 9 are shown. The hub curvature 5 is shaped to allow the cover to fit snugly against the hub, and the disc curvature 8 is shaped for aesthetic reasons and optionally to mimic the curvature of the disc. In FIG. 1C, oval vent openings, a triangular vent opening, and the side plate protrusion 3 are shown. In FIG. 1D, the caliper attachment openings 4 are shown.

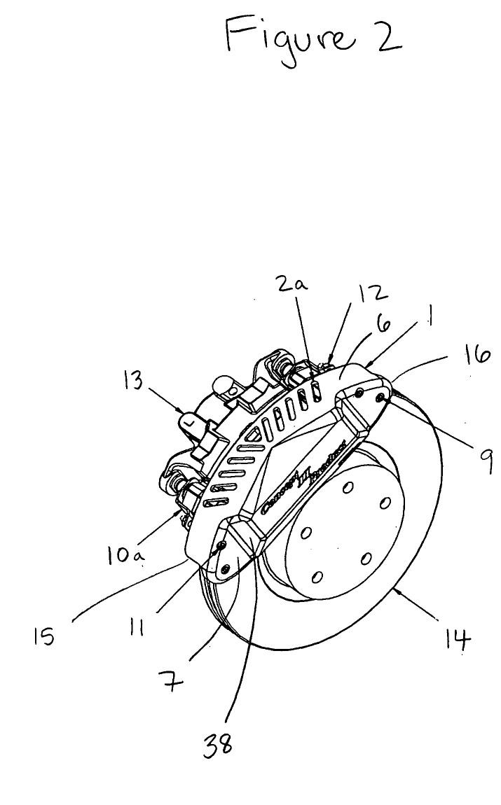

FIG. 2 shows a top front perspective view of an installed left caliper cover kit of this invention. The caliper cover 1 is installed on a standard caliper 13 attached to a standard disc 14. The caliper cover 1 is attached with brackets (left bracket 10a), screws 11, and nuts 12. Oval vent openings 2a, ornamental elements 9, the side plate 7, and the upper plate 6 are labeled. The front panel of the protrusion 38 is also labeled.

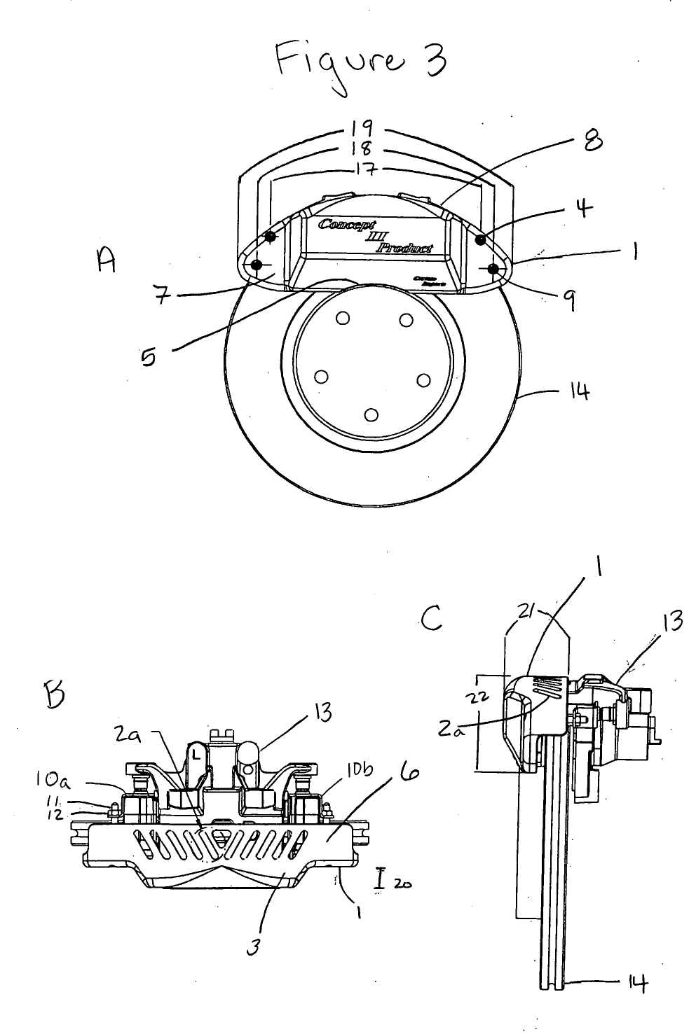

FIGS. 3A-3C show side, top, and back views of installed left caliper cover kits of this invention. In FIG. 3A, the caliper cover 1, side plate 7, disc curvature 8, hub curvature 5, ornamental elements 9, attachment openings 4, and disc 14 are labeled. The attachment opening distance 17, ornamental element distance 18, and side plate width 19 are labeled. In FIG. 3B, the caliper cover 1, left and right mounting brackets 10a and 10b, screws 11, nuts 12, caliper 13, protrusion 3, upper plate 6, and protrusion distance 20 are labeled. In FIG. 3C, the caliper cover 1, oval vent openings 2a, caliper 13, disc 14, upper plate depth 21, and side plate height 22 are labeled.

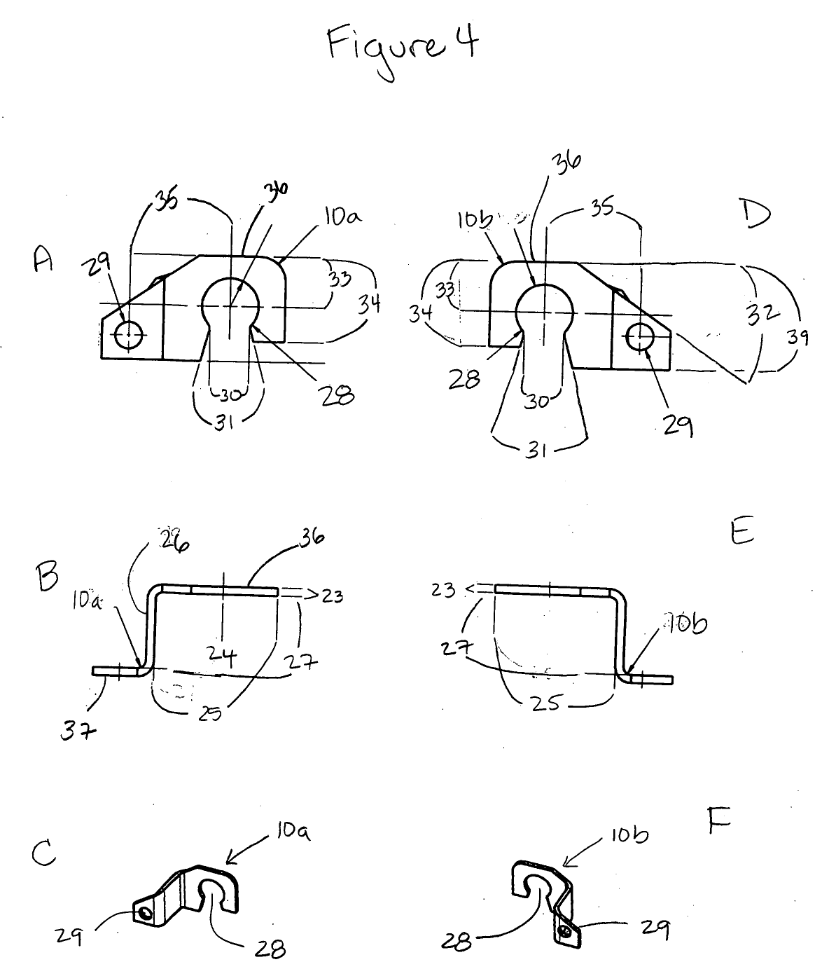

FIGS. 4A-4F show side, top, and top rear perspective views of left and right mounting brackets of caliper cover kits of this invention. In FIG. 4A, the left mounting bracket 10a, cover attachment opening 29, hook opening 28, width of the bottom of the hook opening 30, angle of hook opening 31, the top of the back panel 36 to the center of the hook opening distance 33, the top of the back panel to the bottom of the back panel distance 34, and the center of the hook opening to the center of the cover attachment opening distance 35 are labeled. In FIG. 4B, the left mounting bracket 10a, front panel 37, back panel 36, connecting panel 26, back panel thickness 23, center of hook opening 24, back panel length 25, and connecting panel length 27 are shown. In FIG. 4C, the left mounting bracket 10a, hook opening 28, and cover attachment opening 29 are labeled. In FIG. 4D, the right mounting bracket 10b, cover attachment opening 29, hook opening 28, width of the bottom of the hook opening 30, angle of hook opening 31, the mounting bracket angle, the top of the back panel 36 to the center of the hook opening distance 33, the top of the back panel to the bottom of the back panel distance 34, and the center of the hook opening to the center of the cover attachment opening distance 35 are labeled. In FIG. 4E, the right mounting bracket 10b, back panel thickness 23, back panel length 25, and connecting panel length 27 are shown. In FIG. 4F, the right mounting bracket 10b, hook opening 28, and cover attachment opening 29 are labeled.

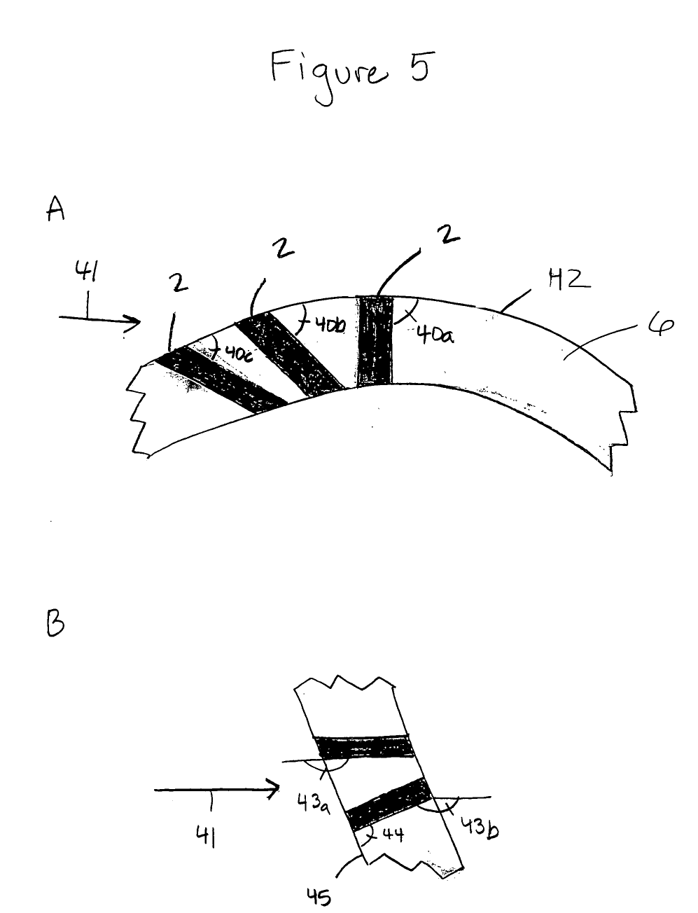

FIG. 5A shows a longitudinal cross-section of a cutaway of an upper plate 6 showing angles of vent openings 2 relative to a tangent to the upper plate surface 42. The vent opening angles 40 are labeled. 40a is at 90 degrees, 40b is less than 90 degrees, and 40c is less than 40b. As the upper plate curves further around the covered caliper, the vent opening angle relative to the surface optionally increases again. The approaching air direction 41, the opposite of the direction that the caliper cover is approaching the air, is labeled. FIG. 5B shows a cross-section from above through a front panel of a side plate protrusion showing vent opening angles 43 relative the approaching air direction 41. Angle 43a is 180 degrees, maximizing passage of air and dirt/debris/dust while minimizing visibility of the caliper from the exterior of the vehicle, and 43b is less than 180 degrees. The vent opening at an angle of less than 180 degrees also is at a 90 degree angle 44 relative to the side plate protrusion surface 45.

This invention provides caliper covers, caliper cover kits, and methods for cooling caliper brake mechanisms that prevent brake fade and prevent brake malfunction caused by debris from the road, while improving the appearance of the caliper braking mechanism and preventing transfer of braking dust from the brake pads to the wheels

The caliper covers of this invention have a plurality of vent openings for directing air to a covered caliper. The caliper covers each have a side plate having an outer periphery, and an upper plate connected to the periphery of the side plate. The caliper covers and kits of this invention are strong and light enough and of such a design and shape to attach well to a caliper, to not interfere with vehicle function, and to be more aesthetically appealing than an uncovered caliper. The caliper mounting bracket mounts over the stationary section of the brake caliper at the junction of the support shaft and the caliper casting. At this point, there is a round protruding boss. The mounting bracket has a round hole slightly larger than the boss with a slot slightly smaller than the hole and extending from the edge of the hole and breaking through the outer edge of the bracket. The slot is made to slip over the shaft, the hole then pilots onto the boss of the caliper casting trapping the bracket in postition. The side plate and upper plate of an installed cover decrease the visibility of the caliper mechanism from the exterior of the vehicle. Optionally the side plate has a protrusion allowing the side plate to wrap around the caliper and further decrease visibility of the caliper from the front and rear ends of the vehicle. Optionally the side plate completely eliminates visibility of the caliper as viewed from the exterior of the vehicle at the same height as the cover directly above the central axis of the connected disc.

The upper plate has a plurality of vent openings for directing air to a covered caliper. The air directed to the covered caliper through the vent openings prevents brake fading compared to an equivalent caliper cover without vent openings. The shapes of the side plate and the upper plate of the caliper cover and the size, placement, and dimensions of the vent openings are selected to prevent debris from outside the covered caliper from contacting the covered caliper and prevent dust from inside the covered caliper from contacting the wheel connected to the caliper. The shapes and placement of the caliper cover and additional kit components are also selected to not add a substantial amount of drag to the moving vehicle. The size, shapes, quantity, angle, and placement of the vent openings are selected to balance cooling of the caliper braking mechanism by directing air to flow through and preventing the passage of dirt, debris, and dust from passing through the vent holes.

Optionally all of the vent openings are curvilinear in shape, including wherein a portion of the vent openings are ovals or curved triangles. Caliper covers of this invention have vent openings that are capable of preventing debris having an average diameter larger than about 0.75 inch, 0.5 inch, and/or 0.25 inch from passing through any of the vent openings. Optionally the vent openings comprise between about 1% and about 75% or between about 10%/o and about 25% of the area of the upper plate. The upper plate area in FIG. 1 is about 25% holes.

This invention provides caliper covers in which the shapes of the vent openings, the curvature of the upper plate, and/or the angle of the vent openings through the upper plate, relative to the exterior surface of the upper plate, direct air to the covered caliper.

Optionally the side plate has a second plurality of vent openings for directing air to the covered caliper. The second plurality of vent openings are optionally at an angle of about 180 degrees relative to the direction of air approaching the caliper cover when a vehicle on which the caliper cover is installed is moving forward. Optionally the side plate vent openings are on the front panel of a protrusion of the side plate that surrounds a portion of the covered caliper. The size, position, angle, and number of the vent openings in the side plate are similarly chosen to decrease visibility of the caliper and passage of dirt, debris, and dust, while increasing passage of air and cooling of the caliper braking mechanism.

Optionally the upper and side plates are contiguous and/or made from a single mold. This invention provides methods for making caliper covers and caliper cover kits of this invention. This invention provides molds for making caliper covers and caliper cover kits of this invention. Although numerous materials are suitable for use in the present invention, one such material is aluminum alloy castings. Specific casting methods may depend on the quantity of the product to be manufactured, but one such method would be a plaster mold casting.

In plaster mold casting, a plaster, usually gypsum or calcium sulfate, is mixed with talc, sand, asbestos, and sodium silicate and water to form a slurry. This slurry is sprayed on the polished surfaces of the pattern halves which are usually made of brass. The slurry sets in less than 15 minutes to form the mold. The mold halves are extracted carefully from the pattern and then dried in an oven. The mold halves are carefully assembled, along with the cores. The molten metal is poured into the molds. After the metal cools down, the plaster is broken and the cores washed out. Low temperature melting materials such as aluminum, copper, magnesium and zinc can be cast using this process.

The caliper covers of this invention also have a caliper attachment receiving means. In an embodiment of this invention, the receiving means is one or more openings in the cover for receiving the attachment means. In an embodiment, the attachment means comprises one or more caliper mounting brackets and one or more screws. Optionally the brackets and screws are made of the same material and have the same finish as the caliper cover.

This invention provides caliper covers in which the periphery of the side plate and the upper plate are curved at about the same curvature of a disc connected to the covered caliper. The curvature of the upper periphery of the side plate and of the upper plate are selected for aesthetics relative to the connected disc, to decrease visibility of the caliper, to minimally increase drag, to prevent passage of dirt, debris, and dust, to direct air to the caliper, and to cool the caliper when braking.

The caliper covers of this invention are useful for vehicles having two, three, four, or more wheels, including motorcycles, tricycles, automobiles, and trucks. The caliper covers and kits of this invention are useful for disc brakes having calipers. The caliper covers and kits of this invention are useful for rear and front wheels of vehicles having four wheels. If a vehicle only has disc brakes on the front wheels, the caliper covers and kits are only useful on the front wheels.

This invention provides caliper covers and kits made of metal or metal alloy, including aluminum alloy. The surface of the covers of this invention are selected for aesthetics and optionally to minimize a decrease in aesthetics caused by dirt, debris, and/or dust hitting or landing on the covers. Optionally the material and/or surface finish of a caliper cover of this invention is selected for similarity with other accessories on the vehicle.

This invention provides caliper cover kits comprising a caliper cover of this invention and a means for attaching the caliper cover to the covered caliper. Optionally the means for attaching the caliper cover to the covered caliper comprises a left mounting bracket, a right mounting bracket, two screws, and two hex nuts, and the caliper attachment receiving means of the caliper cover comprises two openings for accepting the two screws.

This invention provides methods for cooling a caliper breaking mechanism comprising: providing a vehicle having a disc brake; providing a caliper cover of this invention; providing a caliper cover attachment means; installing the caliper cover over a caliper of the disk brake using the attachment means; and driving the vehicle in forward or reverse whereby air is directed through the vent holes in the caliper cover directly to the caliper breaking mechanism.

This invention provides a caliper cover for a vehicle having four wheels comprising: a protruding side plate having a curved outer periphery and having about two openings for receiving caliper attaching screws, and a curved upper plate connected to the periphery of the side plate, the upper plate having vent openings for directing air to a covered caliper, wherein the vent openings comprise between about 10% to about 25% of the surface area of the upper plate, wherein the vent openings comprise about ten oval vent openings having dimensions of between about one inch and about two inches by between about 0.2 inches and about 0.33 inches, and about one curved equilateral triangular vent opening having a side dimension between about 0.5 inches and about one inch, wherein the caliper cover is made of aluminum alloy, and wherein the caliper cover prevents debris from outside the covered caliper from contacting the covered caliper, prevents dust from inside the covered caliper from contacting a wheel of the vehicle, prevents brake fading compared to an equivalent caliper cover without vent openings, and improves the appearance of the covered caliper.

### EXAMPLE 1

A caliper cover kit illustrated in FIGS. 1-4 is made of Aluminum Alloy 356-T6 and installed on a vehicle. The kit is installed by hanging the brackets on the caliper, placing the cover over the portion of the caliper exterior to the disc, inserting the screw through the cover and through the bracket, and tightening the nuts on the screws. The vent openings in the upper plate of the cover are at 90 degrees relative to the outer surface of the upper plate. The angle of each vent opening relative to the incoming air when the vehicle is driven forwards depends on the location of each vent opening on the curved upper plate. The oval vent openings are 1.26 inches in length. The caliper cover is about 1.04 pounds. Additional dimensions are listed in Table 2. The installed caliper cover kit prevents brake fade, prevents brake malfunction caused by debris from the road, improves the appearance of the caliper braking mechanism, and prevents transfer of braking dust from the brake pads to the wheels. The mounting brackets and attachment hardware can be made of corrosion resistant steel (CRES) commonly referred to as stainless steel.

TABLE 2

| Number | Item | Measurement | |
|---|---|---|---|
| 17 | attachment means distance | 8.25 | inches |
| 18 | cosmetic element distance | 9.27 | inches |
| 19 | caliper cover width | 10.77 | inches |
| 20 | protrusion depth | ??? | |
| 21 | caliper cover depth | 2.51 | inches |
| 22 | caliper cover side plate height | 3.9 | inches |
| 23 | bracket thickness | 0.08 | inches |
| 25 | length of back panel | 1.2 | inches |
| 27 | length of connecting panel | 0.76 | inches |
| 29 | cover attachment opening | 0.265 | inches diameter |
| 30 | width of bottom of hook opening | 0.39 | inches |
| 31 | angle of hook opening | 30 | degrees |
| 32 | bracket angle | 35 | degrees |
| 33 | distance from top to center of | 0.5 | inches |
| | hook opening | | |
| 34 | height of back panel side away | 0.85 | inches |
| | from front panel | | |
| 35 | distance from hook opening center | 1 | inch |
| | to cover opening center | | |
| 39 | height of bracket | 1.05 | inches |

### EXAMPLE 2

A caliper cover kit illustrated in FIGS. 1-4 and is made using CRES 300 Series and given a powder coat finish.

Although this invention has been described with respect to specific embodiments, it is not intended to be limited thereto, and various modifications which will become apparent to the person of ordinary skill in the art are intended to fall within the scope of the invention as described herein, taken in conjunction with the accompanying drawings and the appended claims.

1. A caliper cover comprising: a side plate having an outer periphery, an upper plate connected to said periphery of said side plate, said upper plate having a plurality of vent openings for directing air to a covered caliper, and a caliper attachment receiving means.

2. The caliper cover of claim 1 wherein said side plate and said upper plate prevent debris from outside said covered caliper from contacting said covered caliper and prevent dust from inside said covered caliper from contacting a wheel.

3. The caliper cover of claim 1 wherein said directing air to a covered caliper prevents brake fading compared to an equivalent caliper cover without vent openings.

4. The caliper cover of claim 1 for a vehicle having three, four, or more wheels.

5. The caliper cover of claim 1 wherein all of said vent openings are curvilinear in shape.

6. The caliper cover of claim 1 wherein a portion of said vent openings are ovals or curved triangles.

7. The caliper cover of claim 1 wherein said vent openings prevent debris having an average diameter larger than about 0.75 inch, 0.5 inch, or 0.25 inch from contacting said covered caliper.

8. The caliper cover of claim 1 wherein said vent openings comprise between about 1% and about 75% or between about 10% and about 25% of the area of said upper plate.

9. The caliper cover of claim 1 wherein said periphery of said side plate and said upper plate are curved at about the same curvature of a disc connected to said covered caliper.

10. The caliper cover of claim 1 wherein the shapes of said vent openings, the curvature of said upper plate, and/or the angle of said vent openings through said upper plate, relative to the exterior surface of said upper plate, direct air to said covered caliper.

11. The caliper cover of claim 1 wherein said side plate has a second plurality of vent openings for directing air to said covered caliper.

12. The caliper cover of claim 11 wherein said second plurality of vent openings are at an angle of about 180 degrees relative to the direction of air approaching said caliper cover when a vehicle on which said caliper cover is attached is moving forward.

13. The caliper cover of claim 1 wherein said side plate has a protrusion, having a front panel, for surrounding the portion of said covered caliper protruding exterior to a brake disc connected to said covered caliper, wherein said front panel optionally has vent openings for directing air to said covered caliper.

14. The caliper cover of claim 1 made of aluminum alloy.

15. The caliper cover of claim 1 wherein said side plate and said upper plate are contiguous.

16. A caliper cover kit comprising the caliper cover of claim 1 and a means for attaching said caliper cover to said covered caliper.

17. The kit of claim 16, wherein said means for attaching said caliper cover to said covered caliper comprises a left mounting bracket, a right mounting bracket, two screws, and two hex nuts, and said caliper attachment receiving means of said caliper cover comprises two openings for accepting said two screws.

18. A method for cooling a caliper breaking mechanism comprising:
a) providing a vehicle having a disc brake;
b) providing a caliper cover of claim 1;
c) providing a caliper cover attachment means;
d) installing said caliper cover over a caliper of said disk brake using said attachment means;
e) and driving said vehicle in forward or reverse whereby air is directed through said vent holes In said caliper cover directly to said caliper breaking mechanism.

19. A caliper cover for a vehicle having four wheels comprising:
a) a protruding side plate having a curved outer periphery and having at least, two openings for receiving caliper attaching screws; and
b) a curved upper plate connected to said periphery of said side plate, said upper plate having vent openings for directing air to a covered caliper;
wherein said vent openings comprise between about 10% to about 25% of the surface area of said upper plate;
wherein said vent openings comprise about ten oval vent openings having dimensions of between about one inch and about two inches by between about 0.2 inches and about 0.33 inches, and about one curved equilateral triangular vent opening having a side dimension between about 0.5 inches and about one inch;
wherein said caliper cover is made of aluminum alloy; and
wherein said caliper cover prevents debris from outside said covered caliper from contacting said covered caliper, prevents dust from inside said covered caliper from contacting a wheel of said vehicle, prevents brake fading compared to an equivalent caliper cover without vent openings, and improves the appearance of said covered caliper.

20. (canceled)

21. The caliper cover of claim 1 installed on a disc of a vehicle, wherein said side plate completely eliminates visibility of said caliper from a position at the exterior of said vehicle, at the same height as said cover, and directly above the central axis of said disc.
